(19) United States
(12) Patent Application Publication
(10) Pub. No.: US 2003/0113691 A1
(43) Pub. Date: Jun. 19, 2003

(54) Hollow dental post

(75) Inventors: Jacob Ben-Yaakov, Tel-Aviv (IL); Rafael Himmel, Tel-Aviv (IL)

Correspondence Address: DR. MARK FRIEDMAN LTD., c/o Bill Polkinghorn, Discovery Dispatch, 9003 Florin Way, Upper Marlboro, MD, 20772, US

(73) Assignee: CERMA-TECH LTD.

(21) Appl. No.: 10/176,178

(22) Filed: Jun. 21, 2002

Related U.S. Application Data
(60) Provisional application No. 60/339,776, filed on Dec. 17, 2001.

(51) Int. Cl. A61C 5/08

(52) U.S. Cl. 433/220

(57) ABSTRACT

An easily removable dental post is disclosed. The dental post is provided with a cavity that when necessary to remove the dental post acts as a ream guide or to engage a removing tool such as an Allen wrench. The cavity allows marking of the post through the use of radio-opaque material and the efficient curing of light-curable adhesive.

### FIELD AND BACKGROUND OF THE INVENTION

The present invention relates to the field of dental prosthetics and more particularly, to an easily removable dental post.

One of the most common procedures that a dentist is requested to perform is restoration of a tooth following endodontic treatment. The result of such a procedure is schematically depicted in FIG. 1. In FIG. 1, a tooth remnant 24 has lost a clinical crown slightly above a gum line 42. Tooth remnant 24 has an endontontically treated main root canal 22. Root canal 22 houses a dental post 12. Dental post 12 is firmly embedded in root canal 22 by means of threading on shank 14 of post 12, by cementation or other method.

Retentive head 18 of post 12 protrudes through the damaged tooth line 44 and constitutes the basis for the restoration of the damaged tooth. A matrix 46 is filled with a core material 48. After preparation of a core, an artificial crown 50 covers the core, completing the restoration of tooth remnant 24.

In general, two types of dental post and core systems are known in the art: “active” or screw-in type systems and “passive” type systems. Active dental post and core systems mechanically engage the walls of the root canal and tooth dentin. Passive dental post and core systems are bonded in endodontically treated teeth utilizing cements or other adhesives.

In U.S. Pat. No. 5,915,970, included by way of reference as if fully set forth herein, is found a survey of dental posts and dental post and core systems.

Although it is desirable that the endodontic treatment be permanent, it is sometimes necessary as a result of peri-apical diseases, incomplete or inadequate root canal treatments, and dental post failures, to perform endodontic re-treatment. According to Cohen S. and Burns R. “Pathways of the pulp” pp. 794, 799-801, endodontic re-treatment is necessary in up to 34 percent of the cases.

The first step in endodontic re-treatment is removal of crown 22, the core and dental post 12. Removal of dental post 12 from root canal 10 is most often done by drilling-out dental post 12 using a special high-speed carbide bur. Drilling-out dental posts, especially ceramic posts, is difficult and results in the loss of tooth material. As a result, dental post removal is considered a complex and difficult procedure that may be traumatic to the patient. Such a traumatic experience helps reinforce the anti-dentist stereotype typified, for example, in such films as “Little Shop of Horrors”. Removal of a dental post even when performed by a highly skilled dentist, can be risky and can lead to damage to remaining tooth and even to tooth extraction. Missing tooth can be reconstructed, but tooth reconstruction is a long, painful and expensive procedure.

In U.S. Pat. No. 4,178,688, U.S. Pat. No. 5,951,286 and in U.S. Pat. No. 6,280,197 are described devices for the removal of dental posts. A trephine drill bit, being substantially a hollow cylindrical body, with an internal diameter roughly equal to that of the dental post to be removed and saw teeth around the terminal rim, is used to drill-out an amount of tooth tissue flush with the dental post. In U.S. Pat. No. 4,178,688 enough tooth is removed to allow easy extraction of the dental post. In U.S. Pat. No. 5,951,286, a circular groove around the top of the dental post allows the dental post to be engaged with pliers for extraction or in the case of a threaded dental post allows the use of a lever, such as a screwdriver, to extract the threaded dental post. In U.S. Pat. No. 6,280,197 the drill bit automatically engages and rotates the dental post inside the tooth, allowing the extraction of the dental post. Use of these devices necessarily removes a considerable amount of tooth tissue, weakening the tooth. Further, the use of pliers in U.S. Pat. No. 5,951,286 or the dental post rotation of U.S. Pat. No. 6,280,197 cause stress to the tooth, which may lead to cracking or splitting of the tooth. In such a case, the whole tooth must be extracted.

In U.S. Pat. No. 5,173,049 is described a method of loosening a dental post for removal by introducing a liquid in the proximity of the dental post and evaporating the liquid with the help of a laser. The resulting cavitation jiggles the dental post, breaking any adhesive around the dental post, loosening it. Once the entire adhesive is broken, the dental post is easily extracted. This procedure involves laser cutting of the dentin, resulting in tooth structure loss. This method is inefficient, weakens any remaining tooth structure and can cause tooth-cracking stress.

Ultrasonic vibrations have also been employed to aid in the removal of dental posts, by loosening the bound between adhesive and the dental post itself. The heat and vibrations produced often damage the remaining tooth material.

Removable dental posts have been described in the art. French Patent 8,515,527 and U.S. Pat. No. 5,326,263 both disclose tapered dental posts. The tapering is designed to ease dental post extraction. The purpose of these dental posts is to allow the temporary attachment of a dental prosthetic for a relatively short time. As such, the removable dental posts are further configured to be easily removable. For example, whereas permanently installed dental posts are often configured with reliefs, threads or grooves on the dental post shank, the removable dental posts have a smooth outer surface, thus are rendered unsuitable for use as permanent dental posts.

In German patent application DE 3901640 (also known as French patent 2,626,167 or British patent GB 2,214,087), a dental post made of composite material having a central filament to which surrounding fibers and surrounding resin are not bound is disclosed. The dental post of DE 3901640 is configured to permanently attach a dental prosthetic. When it is desired to remove the dental post, the tip of the central filament is exposed and used to draw out the central filament. The resulting channel is used as a guide for a drill, allowing the remaining resin and fibers making up the dental post to be reamed with only minimal damage to surrounding tooth. Unfortunately, in many cases, during the act of drawing out the central fiber becomes stuck or tears, precluding extraction. Further, such a dental post is necessarily made of composite material limiting the ability to make a dental post according to the teachings of DE 3901640 of other commonly used, and often preferable, materials such as metal or ceramic.

The prior art does not teach of a dental post that is configured both for permanent installation and for simple removal when and if the need arises, without damaging remaining tooth tissue. There is a need for and it would be highly advantageous to have an easily removable permanently installed dental post.

### SUMMARY OF THE INVENTION

The above and other objectives are achieved by the innovative dental post provided by the present invention.

There is provided according to the teachings of the present invention a dental post. The dental post of the present invention is configured as a member for the attachment of a dental prosthetic to a tooth and is configured as prior art dental posts, but characterized by having at least one permanent cavity.

According to a feature of the present invention, the at least one cavity is of a length equal to the shank of the dental post. According to a feature of the present invention the cavity is substantially centered in the shank.

According to a further feature of the present invention, the cross section of the cavity is substantially circular.

According to a further feature of the present invention, the cross section of the cavity is substantially not circular (acircular) and can be, amongst others, rectangular, cross-shaped, oval, ellipse, square, pentagonal, hexagonal and star-shaped.

According to a still further feature of the present invention, the outer surface of the shank can be threaded.

According to a feature of the present invention, the at least one cavity is open at the top end of the shank and is of a length so as to terminate at least 0.2 mm and no more than 3 mm from the bottom end of the shank.

According to a further feature of the present invention, the at least one cavity is open at the top end and at the bottom end of the shank.

According to a feature of the present invention, the at least one cavity is substantially conical in shape and wherein the base of the conical-shaped cavity is open at the top end of the shank.

According to a feature of the present invention, the at least one cavity is at least partially filled with a radio-opaque material. According to a further feature of the present invention, the radio-opaque material is substantially softer than a material from which the member is fashioned.

According to a further feature of the present invention, the outer surface of the shank has features such as protrusions, serrations, grooves and threads.

There is also provided according to the teachings of the present invention a method of preparing a tooth root canal for attachment of a dental prosthesis by: a. providing a dental post having a cavity, the cavity opening at the top end of the dental post where the dental post is made of a radio-transparent first material; b. at least partially filling the cavity with a radio-opaque second material; and c. fitting the dental post into the tooth root canal; where the second material is softer than said first material. According to a feature of the present invention, the filling (b) precedes the fitting (c). According to another feature of the present invention, the fitting (c) precedes the filling (b).

According to a feature of the present invention, the second radio opaque material is fluid (e.g. liquid, gel, suspension, slurry, cream)

According to still further feature of the present invention, filling includes injection the second material into the cavity, for example, with the help of a needle and syringe.

There is also provided according to the teachings of the present invention a method for attaching a dental post into a tooth root canal by: a) placing an amount of a light-curable adhesive in the tooth root canal, the light-curable adhesive configured to cure upon exposure to light having a first wavelength; b) fitting a dental post having a hollow cavity into the tooth root canal, the dental post made of a first material, the first material being transparent to the first wavelength of light; c) putting a light source into the hollow cavity; and d) activating the light source within the hollow cavity. According to a feature of the present invention, the light source includes a light-guiding fiber.

There is also provided according to the teachings of the present invention a method for removing a dental post from a tooth root canal by a) providing a dental post having a shank and a cavity in the shank; b) exposing a cross section of the cavity; c) inserting a part of a removal device into the cross section of the cavity; and d) activating the removal device, effecting removal of the dental post.

According to a feature of the present invention, the part of the removal device inserted is an abrasive device (such as a bur or drill) and the activation leads to reaming of the shank, effecting erosion and subsequent removal of the dental post.

According to a feature of the present invention, the shank of the provided dental post is threaded and the part of the removal device inserted is configured to engage surfaces of the cavity upon rotation of the inserted part of the removal device, effecting rotation and subsequent removal of the dental post. Clearly, when this feature is applied, it is advantageous that the cross section of the cavity be acircular.

### BRIEF DESCRIPTION OF THE DRAWINGS

The invention is herein described, by way of example only, with reference to the accompanying drawings, wherein:

FIG. 1 (prior art) is a schematic depiction of a cross-section of a post and core within a tooth;

FIGS. 2A-2C are schematic depictions of archetypal shanks with cavities of dental posts of the present invention;

FIGS. 3A-3C are schematic depictions of threaded dental posts of the present invention having acircular cavities;

FIGS. 4A-4C are schematic depictions of dental posts of the present invention having retentive heads;

FIGS. 5A-5B depict removal of a dental post of the present invention by reaming; and

FIGS. 6A-6B depict removal of a threaded dental post of the present invention by rotation using a removal tool.

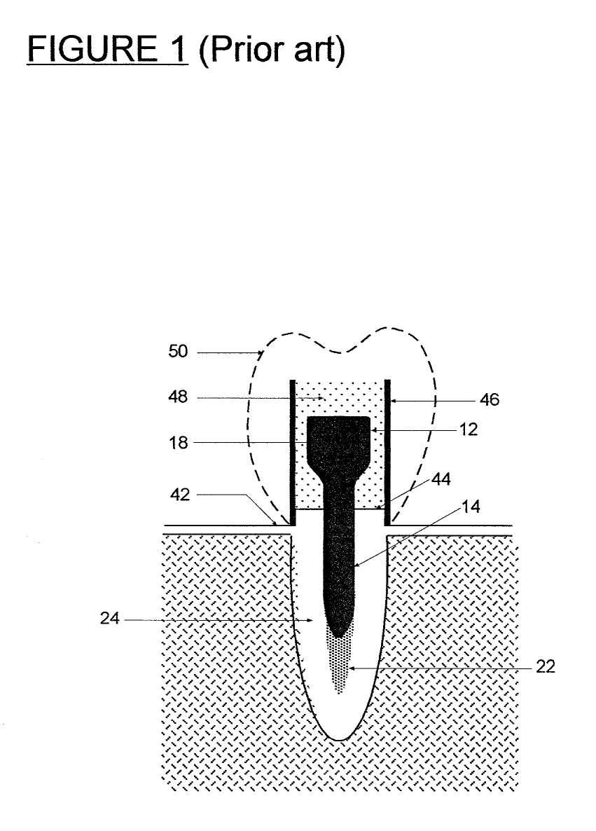

### DESCRIPTION OF THE PREFERRED EMBODIMENTS

The present invention is an innovative dental post, which allows for secure attachment of a dental prosthetic but which can also be easily removed when necessary with little or no damage to the tooth from which the post is removed. This is achieved by providing a cavity in the shank of the dental post, the cavity extending from the top end of the shank towards the bottom (apical) end of the shank. The cavity can either serve as a guide for reaming the post out of the tooth or to engage a removal instrument such as a screwdriver or Allen (hex) wrench.

The principles and operation of a dental post according to the present invention may be better understood with reference to the drawings and the accompanying description.

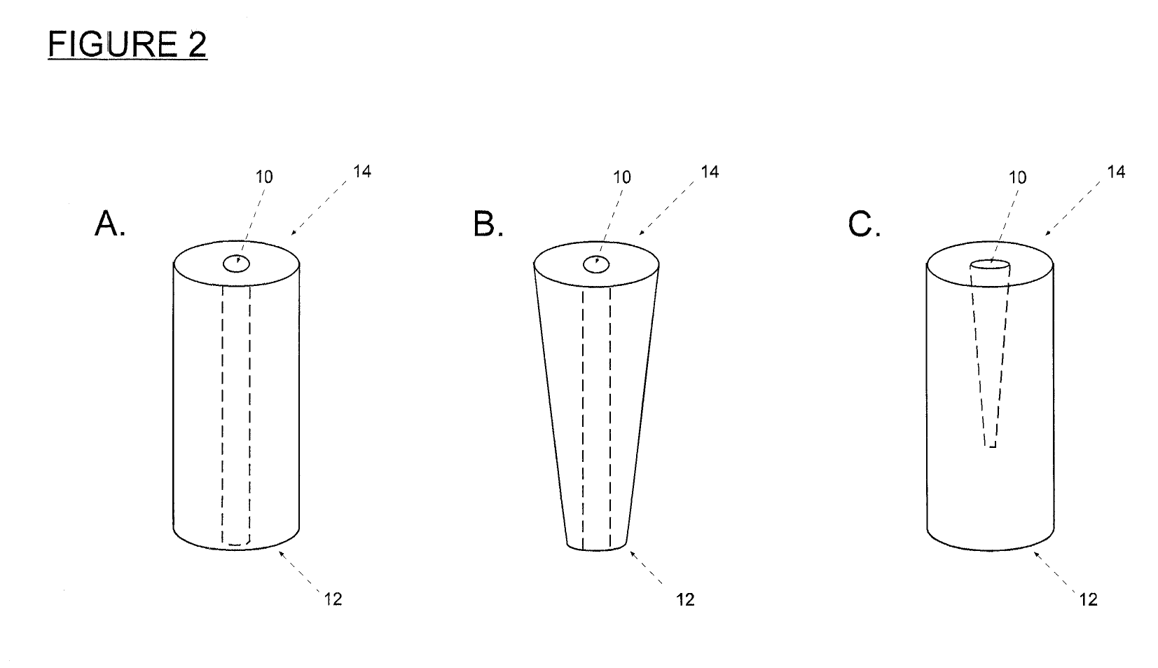

In FIG. 2, three archetypal shanks of dental posts of the present invention are depicted. FIG. 2A depicts a straight walled shank with a parallel-walled cavity 10, 2B a tapering shank (substantially a truncated cone shape) with a parallel-walled cavity 10, and FIG. 2B a straight-walled shank with a tapering (not parallel-walled) cavity 10. In FIG. 2, 12 indicates the bottom (apical) end of the shank, the end which is embedded inside a tooth when the dental post is fitted while 14 indicates the opposite (top) end of the shank. It is seen that the cavity defines a volume that is in communication with the surroundings through the top end of the shank.

The length of the shank of a typical dental post of the present invention is between about 6 mm and about 25 mm.

The diameter of a shank of a typical dental post of the present invention is between about 0.5 mm and about 3 mm. For a typical tapered-shank dental post of the present invention the diameter of a shank at the top end of the shank is between about 0.5 mm and about 3 mm, whereas the diameter of a shank at the bottom (apical) end is between about 0.5 mm and about 2.0 mm.

The length of a cavity of a dental post of the present invention can range from being very shallow (substantially only being a dimple) to being a channel with a length from the top end of the shank extending through the apical end of the shank (as in FIGS. 2A and 2B). Only in limited application is it advantageous that the cavity be only a dimple. Preferably, the length of the cavity is from about 15% to 100% of the length of the shank.

As noted hereinabove, a cavity of a dental post of the present invention is either parallel-walled (FIGS. 2A and 2B) or tapering (FIG. 2C). The cross section of a cavity of the dental post of the present invention can be any shape, and is chosen for ease of manufacture and dependent on the expected method of removal. When it is expected that removal of the dental post be by reaming where the cavity acts as a guide (vide infra), the cross section of the cavity is advantageously, but not necessarily, circular (FIG. 2).

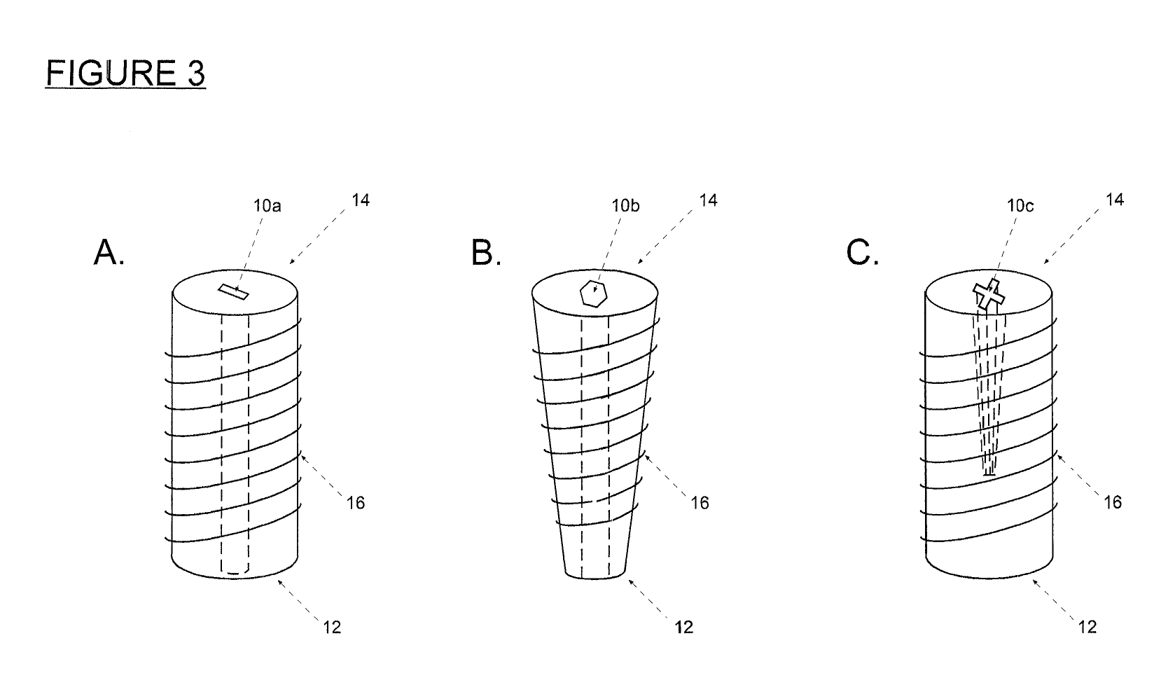

When it is planned that fitting and removal of the dental post be performed by screwing with the help of a threaded shank, the cross section of the cavity is most preferably not circular (acircular) and can have any shape which is useful for engaging a tool such as a screw driver, Allen wrench or the such. As is clear to one skilled in the art, such shapes include, but are not limited to, rectangular (suitable for a standard screwdriver), cross-shaped (suitable for a Phillips screwdriver), oval, ellipse, square, pentagonal, hexagonal (suitable for an Allen wrench) and star-shaped. In FIG. 3A is depicted a dental post of the present invention having a cavity 10a with a slot-shaped (rectangular) cross section suitable for engaging a standard screwdriver. In FIG. 3B is depicted a dental post of the present invention having a cavity 10b with a hexagonal cross section suitable for engaging a Allen wrench. In FIG. 3C is depicted a dental post of the present invention having a cavity 10c with a cross-shaped cross section suitable for engaging a Philips screwdriver.

The inner dimensions of a cavity 10 at the top end of a shank of a dental post of the present invention can range from between about 0.1 to about 0.8 mm.

The shank of a dental post of the present invention can be smooth. Preferably, like prior art dental posts, the outer surface of the shank of a dental post of the present invention is not smooth. When a dental post is designed to be attached in a tooth using an adhesive, the shank surface advantageously has reliefs, patterns, threads or serrations to improve dental post retentivety. When a dental post is designed to be screwed into and out of a tooth, threads are fashioned on the shank, for example, threads 16 in FIG. 3. Other features that can be added to the surface of a shank of a dental post of the present invention are grooves and the such to prevent rotation or to act as vents to allow air and liquid to escape during fitting (as taught in U.S. Pat. No. 5,073,112).

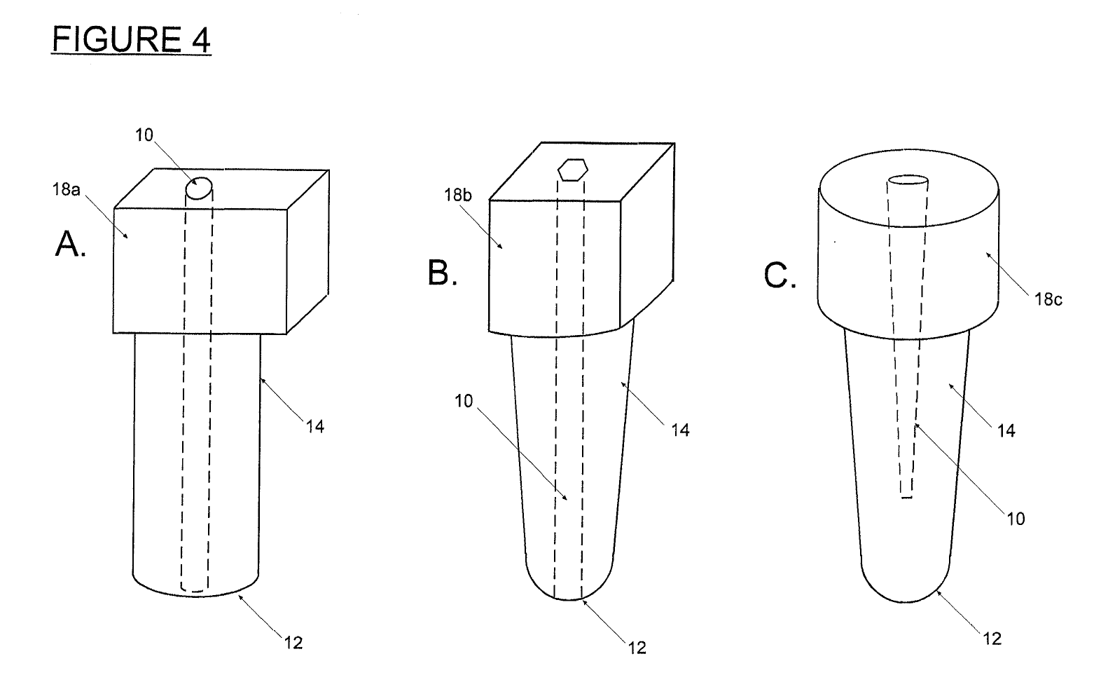

A first general embodiment of the dental post of the present invention consists substantially only of a shank, the shank having at least one cavity, as depicted in FIG. 2 and FIG. 3. A second general embodiment of the dental post of the present invention consists, in addition to a shank, a retentive head 18, see FIG. 4. When a dental post of the second general embodiment of the present invention is installed in a tooth, retentive head 18 is not inserted into the root canal, but rather protrudes therefrom so as to form a convenient base for the attachment of other parts of a dental prosthesis, namely a core. It is most advantageous that a retentive head be of a size and shape so as to act as a core and allow direct attachment of a crown without necessitating a separate core. In the art many and varied shapes of retentive heads are known.

In FIG. 4 are depicted three dental posts of the present invention with retentive heads.

In FIG. 4A is depicted a dental post with a box-shaped retentive head 18a. In the dental post depicted in FIG. 4A parallel-walled circular cross-section cavity 10 extends from the top of head 18a through apical end 12 of shank 14.

In FIG. 4B is depicted a dental post with a cubic retentive head 18b. In the dental post depicted in FIG. 4B parallel-walled hexagonal cross-section cavity 10 extends from the top of head 18b through apical end 12 of tapered shank 14, shank 14 having a rounded-cone shape.

In FIG. 4C is depicted a dental post with a cylindrical retentive head 18c. In the dental post depicted in FIG. 4C not-parallel-walled circular cross-section cavity 10 extends from the top of head 18c to roughly ⅔ the length of shank 14. In the dental post depicted in FIG. 4C, cavity 10 does not extend to apical end 12 of rounded-cone shaped shank 14.

It is clear to one skilled in the art that the dimensions and surface features of a dental post of the present invention are determined by the material and method used to fashion the dental post and by required performance parameters, such as strength, flexibility and retentivity.

A dental post of the present invention can be fashioned from any of the materials known in the art to be useful for dental posts. Included are medical-grade metals, preferably, pure titanium and alloys of titanium (such as titanium 6AL-4VD), stainless steel, cobalt chromium, nickel chromium, gold, platinum-iridium alloys, palladium and palladium alloys.

The methods use in fashioning a metal dental post of the present invention is preferably fashioned by methods such as free-forming, metal injection molding, extrusion, centrifugal casting, precision casting, machining and combinations thereof.

Included materials are also ceramics, especially ceramics made from oxides such as zirconium, yttrium, hafnium, aluminum, titanium, magnesium, silicon, cerium, boron, calcium, potassium, vanadium, sodium, lanthanum, and iron oxides. A preferable ceramic material for fashioning a dental post of the present invention is a combination of about 0.20% to about 90% aluminum oxide with a zirconium oxide alloy 3Y-TZP. As is known to one skilled in the art, such ceramic materials have superior mechanical properties and are commonly used in medical applications. The exact ratio of components of the ceramic materials is determined by the relative importance of the opposing requirements of strength and aesthetics.

The methods use in fashioning a ceramic dental post of the present invention is preferably fashioned by methods such as free-forming, ceramic injection molding, extrusion, centrifugal casting machining and combinations thereof.

Further included materials are composite materials, especially where the resin of the composite material includes thermoplastics such as polyethylene, polypropylene, polysulfone, polycarbonate, polyimide, epoxy-based materials, polyester, polyolefin, acrylic, methacrylic monomer, polyolefin, polyurethane, styrene and mixtures thereof. In addition to the resins, the composite materials preferable include fibers, chopped fibers, powders and mixtures thereof made of quartz, glass, borosilicate glass, lithium aluminum silicate, barium aluminum silicate, strontium, zinc glass, colloidal silica, zirconia, ceramic materials, Kevlar® (DuPont), carbon and graphite

The methods use in fashioning a composite dental post of the present invention is preferably fashioned by methods such as free-forming, pultrusion, filament winding, braiding, injection molding, resin transfer molding, autoclave cure, press molding machining and combinations thereof

Manufacture of the dental post of the present invention, irrespective of the material used, is most preferably performed using either injection molding or any of the free-forming techniques.

For example, when manufactured using injection molding a dental post of the present invention can be directly fashioned including head and shank surface features as well as cavities.

Also for example, when manufactures using free-forming techniques, a dental post of the present invention is directly and accurately fashioned, including head and shank surface features as well as cavities. Specifically, as each succeeding powder layer is fused, areas of powdered layers in locations and areas destined ultimately to correspond to the cavity are not fused. Upon completion of assembly and fusing of the entire dental post, non-fused powder is removed, for example by suction.

The method of manufacture of a dental post of the present invention having a retentive head is dependent on the material from which the dental post itself is made. For virtually all materials used, it is possible to fashion a large dummy from which the shank and retentive head are machined in the usual way. When the dental post is made of cast or molded materials, or using free forming, it is advantageous to fashion the shank and the retentive head directly.

It is clear to one skilled in the art that fitting and use of a dental post of the present invention is substantially identical to fitting and use of a prior art dental post and needs not be discussed hereinfurther. As noted hereinabove, fitting can be accomplished by a variety of adhesives or by mechanical methods such as screwing the dental post into the tooth itself.

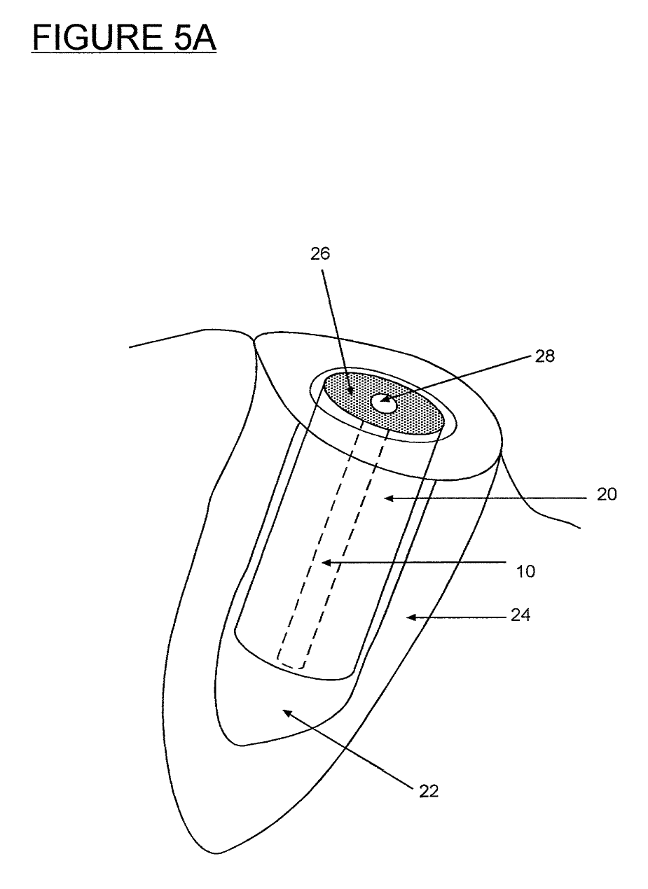

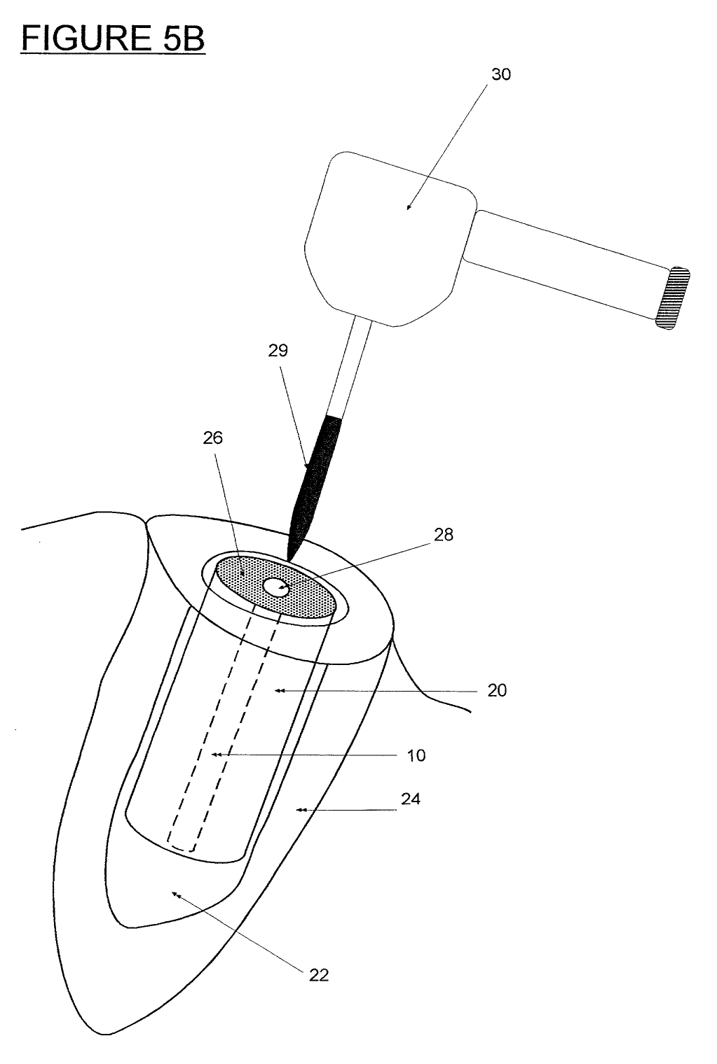

A first embodiment of removal of a dental post of the present invention is depicted in FIG. 5. In FIG. 5A is depicted a dental post 20 of the present invention embedded in a root canal 22 of a tooth remnant 24. In FIG. 5A, the crown and core attached to post 20 have been removed, for example by cutting or sawing. Exposed is a cross section 26 (shaded for clarity) of dental post 20 and a cross section 28 of cavity 10. In FIG. 5B, exposed cavity cross section 28 is used as a guide for a bur 29 attached to dental drill 30 (or other such device) to ream out post material, as well as adhesive remnants without damaging any tooth tissue.

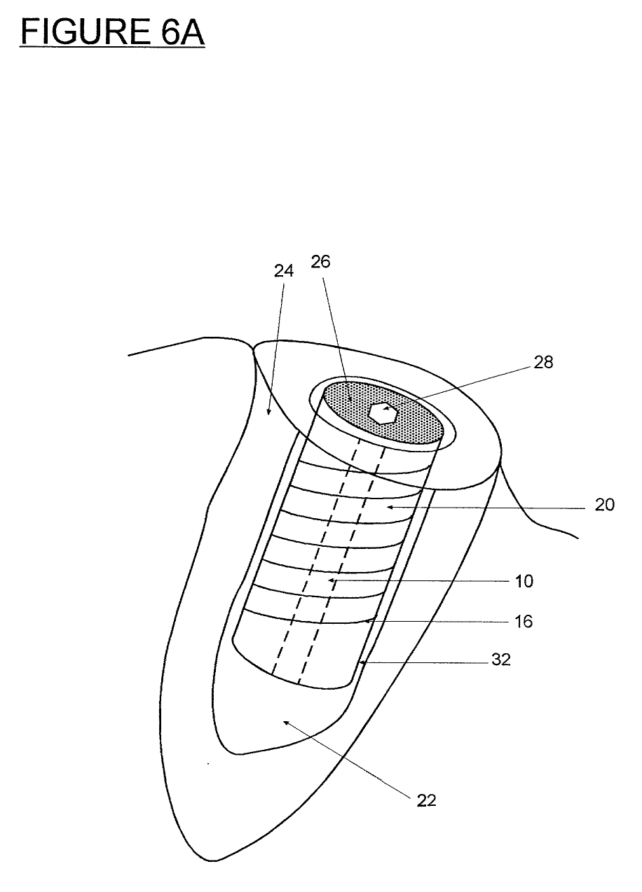

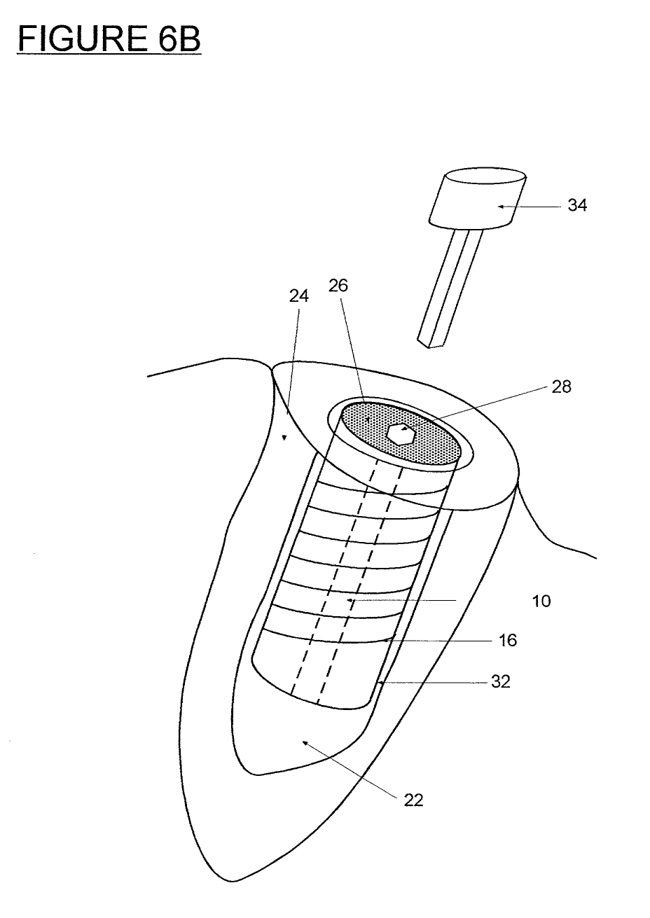

A second embodiment of removal of a dental post of the present invention is depicted in FIG. 6. In FIG. 6A is depicted a threaded dental post 32 of the present invention embedded in a root canal 22 of a tooth remnant 24. In FIG. 6A, the crown and core attached to post 32 have been removed, for example by cutting or sawing. Exposed is a cross section 26 (shaded for clarity) of dental post 32 and a hexagonal cross section 28 of cavity 10. Also seen are threads 16 on the shank of dental post 32.

In FIG. 6B, exposed hexagonal cavity cross section 28 is engaged with a removal tool, in FIG. 6B an Allen (hex) wrench 34. The tip of wrench 34 is inserted through exposed cavity cross section 28 and rotated so as to engage the inner walls of cavity 10 causing rotation of dental post 32. Due to the action of threads 16 during rotation, dental post 16 is extracted from root canal 22. Release of threads 16 and dental post 16 from adhesive present can be performed using moderate vibration of dental post 16 with the help of an ultrasonically vibrating probe tip inserted into cavity 10 through exposed cavity cross section 26.

It is clear to one skilled in the art that one of the primary advantages of a dental post of the present invention arises from the length of the cavity. Wherever the shank of a post is cut, a cross section of the cavity is exposed that is suitable for simple removal of the dental post in its entirety.

It cannot be guaranteed that the dentist who installed a dental post of the present is the one who removes the same dental post. Further, it is possible that the dental records of a patient not be available when it is necessary to remove the post. It is thus preferable that there be a way to mark the cavity of a dental post of the present invention. A dentist preparing a patient for removal of a dental prosthesis can interrogate the mark and accordingly plan removal of the dental post of the present invention.

One method of marking a dental post of the present invention is to fashion the dental post from a material or to impregnate the dental post with a material that is radio-opaque, as is well-known to one skilled in the art. By radio opaque is meant that the material appears distinctly in a dental imaging device, most commonly an imaging device based on the projection and detection of X-rays. Advantageously, the dental post itself is radio-transparent, and the cavity is filled with a material that is both radio opaque and does not interfere with the removal function of the cavity. Such materials are well known in the art and include suspensions or slurries of radio-opaque substance in relative soft matrices such as gum, rubber or resins. The cavity can be filled with the radio-opaque material before or after fitting of the dental post in the tooth of the patient. When filling is performed after fitting, the radio-opaque material is preferably substantially liquid and introduced into the cavity in the usual way, for example with the help of a syringe and needle. One skilled in the art is well acquainted with radio-opaque materials suitable for use as described hereinabove.

The use of light curable adhesives in attaching dental posts is known in the art, see for example U.S. Pat. No. 5,073,112 or U.S. Pat. No. 6,282,013. A light-curable adhesive is put in a prepared tooth, and a dental post, fashioned from a transparent or light-directing material, is put in place and excess adhesive removed. A light source is used to illuminate the adhesive through the dental post. This is a time-consuming process and may lead to unevenly cured adhesive. The cavity of a dental post of the present invention can be used to overcome this disadvantage. Light-curable adhesive and a transparent dental post of the present invention are installed in a usual way. A light source of proper dimensions, such as a fiber optic guiding light from a dental laser or other source of light is then inserted into the cavity. It is clear to one skilled in the art that curing of light curable adhesive in this fashion is preferable to light curing through a prior art transparent or light-directing dental post.

It is important to note that included in the term “light-curable adhesive” are also the popular “dual-cure adhesives”, that is adhesive mixtures which only partially or of which only one of a plurality of components actually cures under illumination.

After the light source is removed, the cavity can be filled with radio-opaque material as described hereinabove.

It is important to note that the present invention is not limited to the embodiments described herein but also relates to all kinds of modifications thereof, insofar as they are within the scope of the claims.

What is claimed is:

1. A member for the attachment of a dental prosthetic to a tooth comprising a dental post having a shank with an outer surface, a length, a bottom (apical) end and a top end, said shank having at least one cavity.

2. The member of claim 1 wherein said at least one cavity is of a length equal to a length of said shank.

3. The member of claim 1 wherein said cavity is substantially parallel-walled.

4. The member of claim 1 wherein at least one of said at least one cavity has an acircular cross-section.

5. The member of claim 4 wherein said cross-section has a shape chosen from the group consisting of rectangular, cross-shaped, oval, ellipse, square, pentagonal, hexagonal and star-shaped.

6. The member of claim 1 wherein at least one of said at least one cavity has a circular cross-section.

7. The member of claim 1 wherein said at least one cavity is open at said top end and is of a length so as to terminate at least 0.2 mm and no more than 3 mm from said bottom end.

8. The member of claim 1 wherein said at least one cavity is substantially conical in shape and wherein a base of said at least one conical-shaped cavity is open at said top end.

9. The member of claim 1 wherein said at least one cavity is filled with a radio-opaque material.

10. The member of claim 9 wherein said radio-opaque material is substantially softer than a material from which the member is fashioned.

11. The member of claim 1 where on said outer surface of said shank are features selected from the group consisting of protrusions, serrations, grooves and threads.

12. A method of preparing a tooth root canal for attachment of a dental prosthesis comprising:
a. providing a dental post with a cavity, said cavity opening at a top end of said dental post and said dental post made of a radio-transparent first material;
b. substantially filling said cavity with a radio-opaque second material; and
c. fitting said dental post into the tooth root canal;
wherein said second material is softer than said first material.

13. The method of claim 12 wherein during said filling said second material is fluid.

14. The method of claim 13 wherein said filling comprises injection of said second material into said cavity.

15. A method of attaching a dental post into a tooth root canal comprising:
a. placing an amount of a light-curable adhesive in the tooth root canal, said light-curable adhesive configured to cure upon illumination with light having a first wavelength;
b. fitting a dental post with a hollow cavity into the tooth root canal, said dental post made of a first material, said first material transparent to said first wavelength of light;
c. putting a light source into said hollow cavity; and
d. activating said light source within said hollow cavity so as to substantially illuminate said light-curable adhesive.

16. The method of claim 15 wherein said light source comprises a light-guiding fiber.

17. A method for the removing of a dental post comprising:
a. providing a dental post having a shank and a cavity in said shank;
b. exposing a cross section of said cavity;
c. inserting a part of a removal device into said cross section; and
d. activating said removal device, effecting removal of the dental post.

18. The method of claim 17 wherein said part of said removal device is an abrasive device and said activation leads to reaming of said shank, effecting erosion and subsequent removal of the dental post.

19. The method of claim 18 wherein said abrasive device comprises a bur.

20. The method of claim 17 wherein said shank is provided with a threaded outer surface and said part of said removal device is configured to engage surfaces of said cavity upon rotation of said part of said removal device, effecting rotation and subsequent removal of the dental post.

21. The method of claim 20 wherein said cross section of said cavity is acircular.

22. The method of claim 21 wherein said cross section of said hollow cavity is chosen from the group consisting of rectangular, cross-shaped, oval, ellipse, square, pentagonal, hexagonal and star-shaped.
